(19) United States
(12) Patent Application Publication
(10) Pub. No.: US 2011/0010245 A1
(43) Pub. Date: Jan. 13, 2011

(54) LOCATION-BASED ADVERTISING METHOD AND SYSTEM

(75) Inventors: Seth M. Priebatsch, Boston, MA (US); Adam Finkelstein, Princeton, NJ (US); Valeri Karpov, Fair Lawn, NJ (US)

Correspondence Address: FOLEY HOAG, LLP;PATENT GROUP, WORLD TRADE CENTER WEST, 155 SEAPORT BLVD, BOSTON, MA, 02110, US

(73) Assignee: SCVNGR, Inc., Boston, MA (US)

(21) Appl. No.: 12/708,746

(22) Filed: Feb. 19, 2010

Related U.S. Application Data
(60) Provisional application No. 61/153,716, filed on Feb. 19, 2009.

(51) Int. Cl. G06Q 30/00

(52) U.S. Cl. 705/14.58

(57) ABSTRACT

A method for providing advertisements to users of mobile devices, includes the steps of: (a) providing a plurality of advertisements and geographic region information associated with each advertisement; (b) receiving from a mobile content provider a request for an advertisement to be delivered to a user of a mobile device along with non-standard data from which the location of the mobile device can be determined; (c) processing the non-standard data to determine the location of the mobile device; (d) identifying a subset of advertisements from the plurality of advertisements having geographic region information matching the location of the mobile device; (e) ranking the advertisements in the subset of advertisements in accordance with one or more parameters; and (f) selecting an advertisement from the ranked advertisements to be transmitted to the mobile content provider for delivery to the mobile device of the user.

### CROSS REFERENCE TO RELATED APPLICATION

This application claims priority from U.S. Provisional Patent Application Ser. No. 61/153,716, filed on Feb. 19, 2009, entitled The SCVNGR Mobile Ad Targeting Algorithm (MATA), which is hereby incorporated by reference.

### BACKGROUND

The present application relates to methods and systems for targeted advertising and, more particularly, to location-based advertising.

### BRIEF SUMMARY OF EMBODIMENTS OF THE INVENTION

A method in accordance with one or more embodiments for providing advertisements to users of mobile devices, includes the steps of: (a) providing a plurality of advertisements and geographic region information associated with each advertisement; (b) receiving from a mobile content provider a request for an advertisement to be delivered to a user of a mobile device along with non-standard data from which the location of the mobile device can be determined; (c) processing the non-standard data to determine the location of the mobile device; (d) identifying a subset of advertisements from the plurality of advertisements having geographic region information matching the location of the mobile device; (e) ranking the advertisements in the subset of advertisements in accordance with one or more parameters; and (f) selecting an advertisement from the ranked advertisements to be transmitted to the mobile content provider for delivery to the mobile device of the user.

In accordance with one or more further embodiments, an advertising system provides advertisements to users of mobile devices. The advertising system includes a computer storage system for storing a plurality of advertisements and geographic region information associated with each advertisement. The advertising system also includes a computer server system programmed to (a) receive from a mobile content provider a request for an advertisement to be delivered to a user of a mobile device along with non-standard data from which the location of the mobile device can be determined; (b) process the non-standard data to determine the location of the mobile device; (c) identify a subset of advertisements from the plurality of advertisements stored at the computer storage system having geographic region information matching the location of the mobile device; (d) rank the advertisements in the subset of advertisements in accordance with one or more parameters; and (e) select an advertisement from the ranked advertisements to be transmitted to the mobile content provider for delivery to the mobile device of the user.

In accordance with one or more further embodiments, a computer program product residing on a computer readable medium has a plurality of instructions stored thereon which, when executed by the processor, cause that processor to: (a) receive from a mobile content provider a request for an advertisement to be delivered to a user of a mobile device along with non-standard data from which the location of the mobile device can be determined; (b) process the non-standard data to determine the location of the mobile device; (c) identify a subset of advertisements from a set of stored advertisements having geographic region information matching the location of the mobile device; (d) rank the advertisements in the subset of advertisements in accordance with one or more parameters; and (e) select an advertisement from the ranked advertisements to be transmitted to the mobile content provider for delivery to the mobile device of the user.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a simplified illustration of a network in which a location based advertising system can be implemented in accordance with one or more embodiments.

FIG. 2 is a simplified flowchart illustrating an advertising method in accordance with one or more embodiments.

FIG. 3 is a simplified flowchart illustrating a method of serving advertisements in accordance with one or more embodiments.

FIG. 4 is a simplified flowchart illustrating a method for ranking advertisements in accordance with one or more embodiments.

### DETAILED DESCRIPTION

The present application is directed to a method and system for providing targeted advertisements to mobile devices. The advertising system uses data received from mobile content providers on the location of mobile device users to identify locally relevant advertisements for the mobile device users. The advertisements can be delivered to users' mobile devices in various ways including, e.g., by text message, and with content delivered to mobile web browsers and mobile device applications. The advertising system has been found to improve results of mobile advertising campaigns by increasing the relevance of the advertisements delivered to users based on user location and other parameters.

The advertising system can process ambiguous or non-standard incoming location-based data from mobile devices and use it to score the relevance of advertisements available from local stores. The ambiguous location-based data can be based, e.g., on content that a mobile device user is viewing that hints at, tangentially reveals, or transmits their location back to the mobile content provider. The ambiguous location-based data can be, e.g., a natural language description of a location (e.g., Starbucks near corner of Marlborough and Lexington).

As discussed in further detail below, the advertising system stores advertisements and related data received from local advertisers. Mobile content providers request advertisements to be delivered to mobile device users and provide information related to the location of the mobile device users. The advertising system processes the data received from the mobile content providers and uses the data to score a set of regionally relevant advertisements and then returns a selected advertisement to the mobile content provider for delivery to a mobile device user.

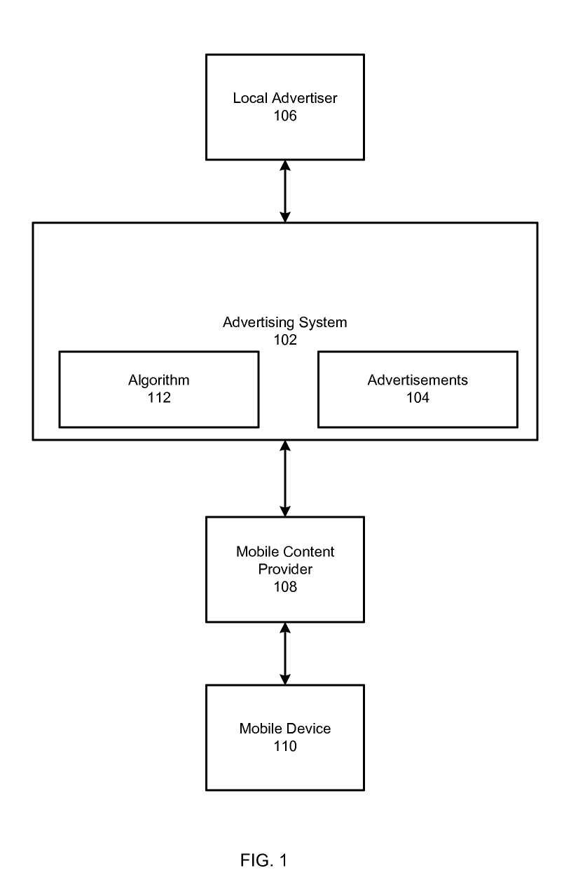

FIG. 1 is a simplified illustration of a network in which an advertising system 102 in accordance with various embodiments can be implemented. The advertising system 102 stores a plurality of advertisements 104 and related information received from a plurality of advertisers such as local merchants 106. The advertisement system 102 receives requests for advertisements from mobile content providers 108, which deliver advertising and content to mobile devices 110 operated by mobile device users. The advertising system 102 uses a mobile advertising targeting algorithm 112 to select advertisements to be delivered to mobile device users based on their location and other criteria as will be described in further detail below.

The advertising system 102 can communicate with mobile content providers 108 and local advertisers 106 over a variety of communications networks including, e.g., the Internet, an intranet, or other network connection.

The advertising system 102 can include an enterprise-level server or other computer server system for performing the functions described herein. The functions of the advertising system 102, including the targeting algorithm 112, can be distributed across one or more virtual or physical computer systems.

The mobile devices 110 can include any portable communications devices such as, e.g., cellular telephones, smart phones, portable digital assistants, and the like.

The advertising system 102 includes a front-end online interface that enables advertisers 106 such as local stores to input their advertisements (including, e.g., current specials, digital coupons, or other offers) and related data (including the store's location and other information). These advertisements provide an inventory of advertisements 104 stored on a computer storage system that have the potential of being locally relevant to mobile device users. The advertising system 102 provides an easy to use interface allowing businesses to quickly and easily develop targeted advertising campaigns that can deliver relevant advertisements to nearby mobile device users.

The advertisements delivered to mobile device users can be displayed with content provided by mobile content providers 108. The advertising system 102 in accordance with various embodiments provides an easy way for mobile content providers 108 to transmit location data (and any other relevant data) to the system 102 for processing by the mobile advertising targeting algorithm 112. The advertising system 102 enables mobile content providers 108 to transmit non-standard forms of location information such as, e.g., transportation stops, names of nearby stores, or places of interest (e.g., the pizza store near 24th street) and many other more subtle variations of location data that can reveal the location of the user. Mobile content providers 108 can pass the information they collect normally, without having to perform any significant processing on their own to meld their data into more conventional or standard forms of location data (e.g., longitude/latitude pairs, zip code, and street address). Mobile content providers often discard such non-standard information because it does not conform to the more common formats mentioned above and has limited utility. The advertising system 102 decreases the amount of work that mobile content providers 108 must perform in order to provide location relevant information.

The mobile advertisement targeting algorithm 112 processes incoming data from mobile content providers 108, ranks available advertisements, and returns a locally relevant advertisement to a mobile content provider 108 for delivery to a given user. The mobile advertisement targeting algorithm 112 determines which mobile advertisement from an inventory of local advertisements 104 should be delivered based on location-based information about a given mobile device 110 and one or more other relevant parameters. The mobile advertisement targeting algorithm 112 can receive location data in a variety of forms including non-standard forms from the mobile content provider 108. The algorithm 112 processes this data in order to determine the user's location in a standardized form such as, e.g., a longitude/latitude pair, street address, or a zip code. The conversion to standardized location data can be performed using various commercially available applications including, e.g., Google Maps API and GeoAPI applications. The algorithm 112 then identifies a given number or subset of all stored advertisements within a geographic region containing the user's location, and scores the identified advertisements according to their relevance to the given user in accordance with one or more parameters. These parameters can include, but are not limited to: proximity of location, relevance to time of day, and contextual relevance. The algorithm 112 generates scores for each of the advertisements in the subset of advertisements. A set of scored advertisements are thereby identified that are the most relevant to the current consumer at his/her current location and in accordance with one or more parameters such as the time of day. The system 102 then returns an advertisement in the set with probability proportional to its score. The most highly scored advertisement is most likely to be returned; however, it is not necessarily the case. The introduction of a nondeterministic element to this process enables a wider variety of advertisements to be delivered, giving the system a broader set of data from which to judge its success rate. The characteristics by which the algorithm 112 measures success, which are discussed in further detail below, can be considered a proxy for the CTR (click through rate) of that advertisement in that region, with a higher CTR being superior to a lower CTR. The selected advertisement is then delivered to a mobile content provider 108, which then delivers it to the mobile device 110.

In accordance with one or more embodiments, once advertisements have been delivered to mobile device users, the system tracks the advertisements to determine whether, e.g., (a) it has been clicked by the mobile device user and (b) if clicked (and if it has a unique coupon code to access a special or promotion) if that coupon code is reported as redeemed by the store owner or advertiser 106.

The advertising system 102 in accordance with various embodiments can produce a high degree of advertisement relevance, resulting in higher CTRs and more successful mobile advertising campaigns.

The system maintains an inventory of locally relevant advertisements 104, and includes a front-and interface that enables local store owners and advertisers 106 to quickly and easily input their advertisements. In accordance with one or more embodiments, the interface allows advertisers 106 to input information by answering simple questions to provide a baseline of data for the mobile ad targeting algorithm 112. By way of example, this process can prompt advertisers 106 for the following information:

A. Inputting Store Location: The advertiser 106 is prompted to input their store's information. The store owner can input information on one store or many stores, e.g., by going through the process multiple times.
Store Name: The advertiser 106 is prompted to input the title of the store for reference.
Store Location: The advertiser 106 is prompted to input store location information. This can be done, e.g., by geocoding in their location using a maps interface.
Region of Relevance: The advertiser 106 is then prompted to select from a set of possible regions of relevance. This selection is used to set the initial radius of that store's region of relevance. The mobile advertisement targeting algorithm 112 generates regions of relevance for each store location. This region initially takes the form of a Gaussian curve centered at the store location whose height slopes off as distance from the store location increases. However, the larger the radius for that particular store, the wider and broader its region of relevance will be. Stores may have different radiuses of relevance. For example, a movie theater that is eight blocks away may be more relevant than a coffee shop that is two blocks away simply because the region of relevance of the movie theater is significantly more spread out. This concept may not be intuitively obvious, and therefore the question can, e.g., be posed to store owners in the following manner: “How far would the average customer travel to reach your store's location?” The interface then provides several answers (e.g., walk one block, walk three blocks, or drive one mile) and uses that information to provide the initial value for the radius that shapes the Gaussian region of relevance.

B. Inputting Advertisement Data: The interface allows the store owner to craft the offer, coupon, or other type of advertisement that will be delivered to mobile consumers on their mobile devices. Aside from being able to input content, store owners can also specify what initial inputs will be passed into the mobile advertisement targeting algorithm 112 for certain parameters such as location, time, and contextual relevance. By way of example, the store owner can be prompted to input the following information:
General Campaign Information: The store owner is prompted to input a title, description, and other information for reference.
SMS Text: The store owner is prompted input text content that will be delivered through SMS content providers.
Mobile Web Text and Image: The store owner is prompted to input text and images that will be delivered through mobile web content providers.
Location Targeting Information: The store owner can be presented with different methods of location targeting. For example, one method is to set the targeting to one of the store owner's pre-entered store locations. This method will then seek to deliver ads within the regions of the relevance for those stores. Another method is to select a broader geographical region (e.g., zip code, neighborhood, or city) and then a region of relevance that spans that geographical area will be assigned for the advertisement in question.
Time Targeting: The store owner can be prompted to input time targeting information. Routing advertisements to mobile consumers when they are nearby the locations being advertised presents the possibility that a mobile advertisement might impel a consumer to alter his/her current path and enter a nearby store. This possibility presents adds a new level of importance to time targeting. By allowing the store owner to select the times during which they would like their advertisements to be served, the mobile advertisement targeting algorithm 112 creates the possibility, e.g., of driving consumers to a coffee shop in the morning with a relevant special or other advertisement or only driving traffic to a sandwich shop outside of lunch hours when they have the spare capacity.
Coupons: As a tracking mechanism to judge the efficacy of a campaign, the store owner can choose to insert a unique coupon identifier into each advertisement delivered. For example, if the advertiser 106 is crafting a campaign to offer 50% off coffee between 6 AM and 10 AM, the advertiser 106 can choose to insert unique coupon identifiers into each message. By recording and then entering online the coupon identifiers that have been redeemed, the advertiser 106 can track the direct success of their campaign. In addition, the tracking information can provide valuable data to the mobile advertisement targeting algorithm 112 to improve subsequent campaigns.
Budget: The advertiser 106 inputs a monthly budget for the campaign.
Launch: The advertiser 106 then sets a launch date and end date for the campaign.

C. Landing Page: If the advertiser 106 is targeting mobile web content providers, it can be useful to provide a mobile web site for the advertisement to link to. Small local store owners often do not have the budget or the expertise to build out a mobile website. The advertising system 102 accordingly provides a quick and easy way for store owners to input custom text and logos, or choose from prebuilt features (such as a click to send me the coupon as SMS), and then launch their custom mobile web page, which is hosted by a system server.

In accordance with one or more embodiments, the mobile content providers communicate with the advertising system 102 through a mobile content provider connection, which is the communication point between the mobile advertisement targeting algorithm 112 and mobile content providers 108 in the network. The mobile content provider connection functionality can be implemented in code that the mobile content providers 108 paste into their applications to request advertisements to be delivered to mobile device users. The application can be standard to those commonly used in advertisement delivering systems; however, the added code allows a variety of location-based data to be accepted by the system along with user history and user tracking information, while coping with some of the limitations of operating on mobile phones.

In accordance with one or more embodiments, the mobile content provider 108 passes several pieces of information to the mobile advertisement targeting algorithm 112 including the user's current location in whatever format the data is collected, the user's ID (if one has been pre-assigned by the system) and any optionally contextual information about the content provided. The system then determines which advertisement is most relevant, returns it to the mobile content provider 108, which then delivers the advertisements to the user. Once the advertisement has been delivered to the mobile device 110, a tracking mechanism can be used to determine if and when the advertisement is clicked or otherwise acted on by the mobile device user.

As discussed above, the mobile advertisement targeting algorithm 112 selects the advertisement to be delivered to the mobile device user. The mobile advertisement targeting algorithm 112 uses information provided by the mobile content provider 108 to determine the location of the mobile device 110. The algorithm 112 then generates a field or subset of N locally relevant advertisements from the region in which the mobile device 110 is located, calling upon the data collected from the local store owners to populate the set. The algorithm 112 considers any other relevant parameters (either those passed in from the mobile content provider 108 such as the context of the content delivered or information relevant to the advertisement itself such as whether the current time in the user's time zone is within the time-targeting parameters that were selected for the campaign.)

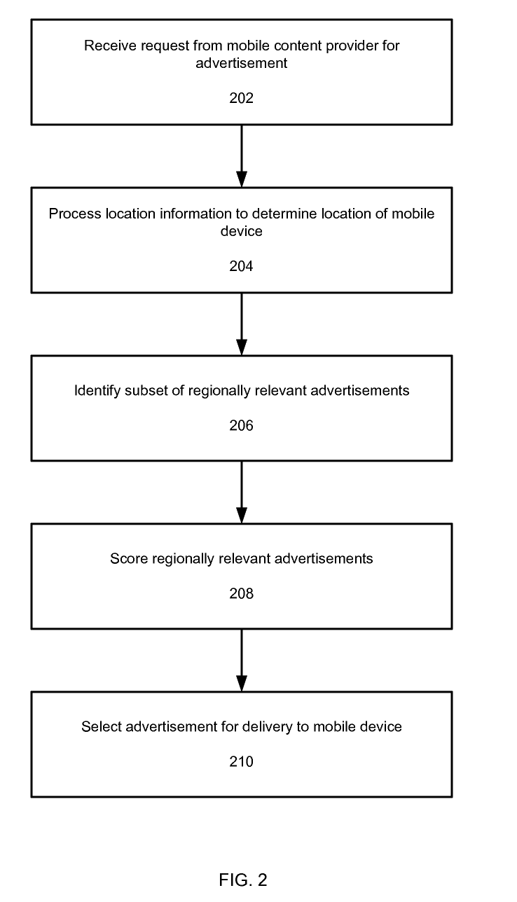

FIG. 2 is a flowchart generally illustrating an advertisement selection process in accordance with one or more embodiments.

At step 202, the algorithm 112 receives a request from mobile content provider 108 for an advertisement to be delivered to a mobile device user. The request is provided with location information of the mobile device 110, which can be in a non-standard format.

At step 204, the algorithm 112 processes the location information to determine the location of mobile device 110.

At step 206, the algorithm 112 collects advertisements associated with a region containing the mobile device location until there are a predetermined number of advertisements (generally greater than 20), forming a subset of advertisements.

At step 208, the algorithm 112 scores the advertisements in the subset based on location proximity and other parameters.

At step 210, the algorithm 112 returns an advertisement with probability proportionate to score to the mobile content provider 108 to be delivered to the mobile device user.

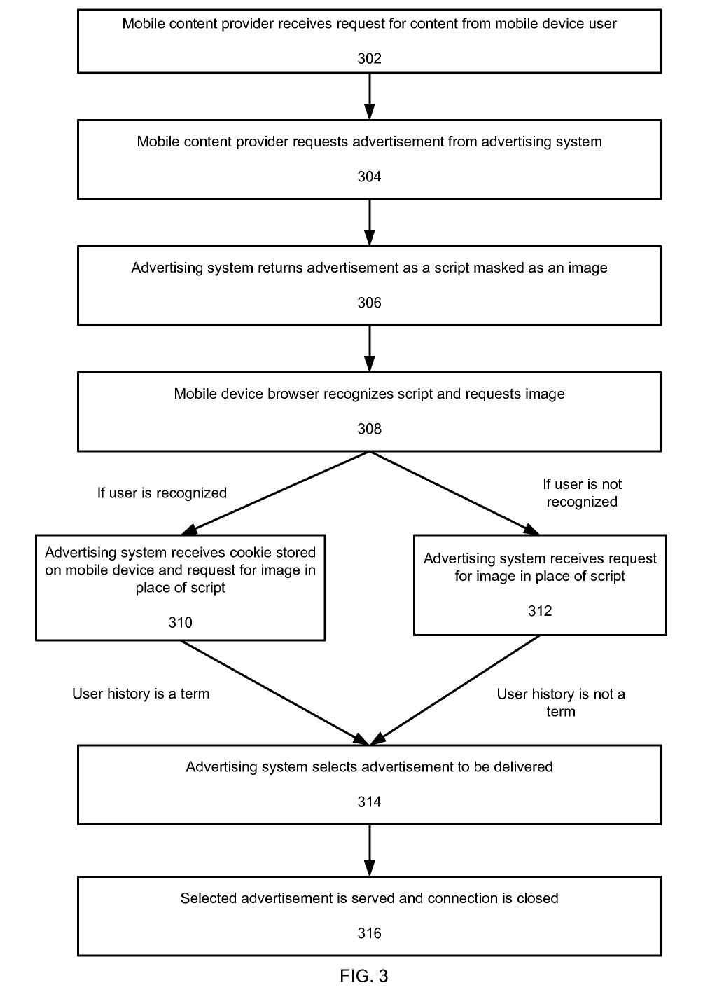

FIG. 3 illustrates a process of delivering advertisements to mobile device users and recognizing the users in accordance with one or more embodiments. At step 302, a mobile content provider 108 receives a request for content from a mobile device user. At step 304, the mobile content provider 108 requests an advertisement from the advertising system 102 to deliver with the content requested by the mobile device user.

On mobile devices where usage of AJAX and other resource intensive asynchronous technologies is severely limited, identifying a user (and tracking their history) becomes difficult. In accordance with one or more embodiments, the advertising system 102 can circumvent this issue by returning a script (e.g., a Python script) that is masked as an image instead of the image itself at step 306. When the user's browser attempts to render this image, it recognizes the script and then makes a request for the image itself at step 308. While this request is being made, any advertisement system cookies on the user's mobile device 110 are passed to the system along with the request for the image at step 310. The cookies allow the system to recognize the user if he or she has previously been identified with a system cookie. This enables the system to track users across multiple mobile content providers 108 and factor user history into advertisement selection by the system. In the event no advertisement system cookies on the user's mobile device 110 are passed to the system 102 and the user is unknown (at step 312), the user history is not used as a parameter and selecting advertisements.

At step 314, the algorithm 112 selects an advertisement to be delivered to the mobile device user. At step 316 the selected advertisement is provided to the mobile content provider 108 for delivery to the mobile device user, and the connection is closed.

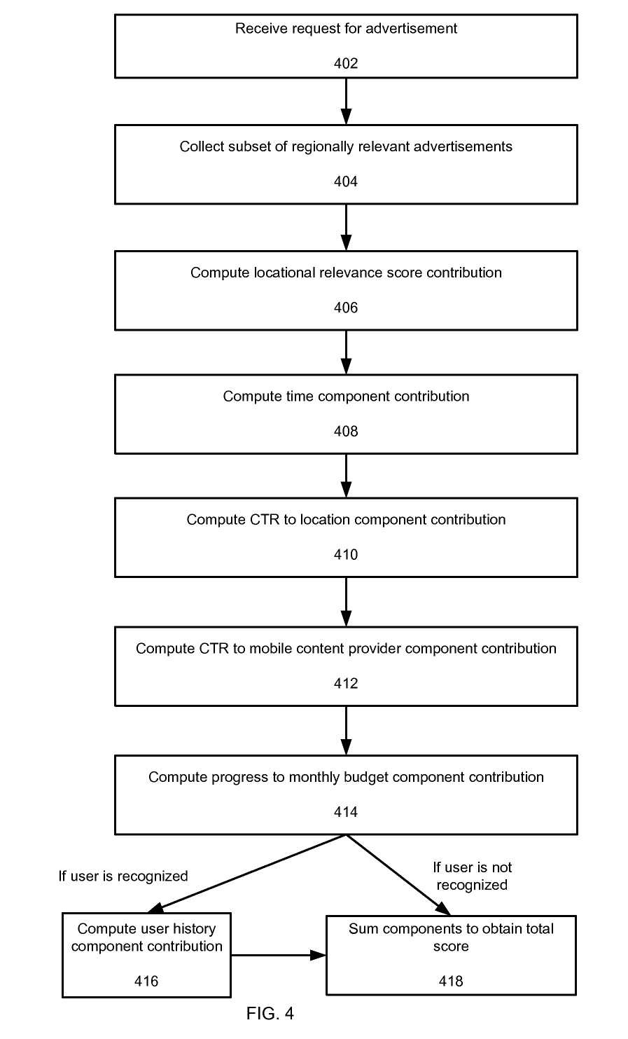

FIG. 4 illustrates an exemplary process of computing a score for advertisements using the mobile advertisement targeting algorithm 112 in accordance with one or more embodiments.

At step 402, the advertising system 102 receives a request for a mobile advertisement from a mobile content provider 108 to be delivered to a mobile device 110.

At step 404, the algorithm 112 gathers a set of regional advertisements based on the location of the mobile device 110. (This is a subset of all advertisements stored at the system 102.) Once a sufficient number of advertisements have been gathered, the targeting system scores each advertisement based on several parameters (including the user's history as determined above) as shown in steps 406-418 and then returns an advertisement to the mobile content provider 108 for eventual delivery to the mobile device 110. Advertisement scoring is performed by computing the locational relevance contribution (step 406), a time component contribution (step 408), a CTR to location component contribution (step 410), a CTR to mobile content provider component contribution (step 412), progress to monthly budget component contribution (step 414), and if the user is recognized, a user history component contribution (step 416). The added components are summed to obtain a total score at step 418.

Pulling up a set of regionally relevant advertisements at step 404 can be accomplished by setting some large Nₘₐₓ (a number of advertisements to attempt to pull) and some large value Dₘₐₓ (a radius around the user's location in which to pull those advertisements). Starting at some small radius R (smaller than the Dₘₐₓ) and expanding outwards, the set of regional advertisements is populated as they fall within R as it expands. This process ends when either Dₘₐₓ or N is exceeded, at which point the advertisements that have been collected are placed into the set of regional advertisements for scoring.

Once a sufficiently large set of regional advertisements has been established, the mobile device targeting algorithm 112 scores each advertisement, where a higher score represents a more relevant advertisement given the parameters provided. By way of example, each advertisement can receive a score ranging from 0 to 100. Then one of the scored advertisements is selected to be returned to the mobile content provider 108 for delivery to the mobile device 110. In accordance with one or more embodiments, the advertisement is selected with probability proportional to its score. This results in the selection of an advertisement with a high score (but not necessarily the highest score).

The 100 possible “points” that comprise the maximum score of an advertisement can be broken into six components, each of which has a maximum possible contribution to the total score of any advertisements. These components are described in greater detail below. The components are illustrated here with reasonable values for their maximum contributions. In the algorithm 112, these maximum contributions can be variables that can be manipulated dynamically to improve results.

To choose an advertisement to deliver to a mobile user, the algorithm 112 begins by assigning a relative score si to all possible ads i. The scores are based on a set of criteria that describe how well matched each advertisement is to a given mobile user, including factors such as location, time of day, historical information about the mobile user, and mobile content served. While a variety of such factors could be combined in a variety of ways, one exemplary formula for calculating the score is:

sᵢ=(kₜTᵢ+k_{d}Dᵢ+k_{c}Cᵢ+kₚPᵢ+k_{b}Bᵢ+kₗLᵢ)^{k}_{ₛ}

where these terms are described as follows:

Time targeting: Tᵢε[0,1] describes how well the current time of day matches the target time for advertisement i. The most straightforward formulation is that the ad campaign chooses a set of hours of the day (or week or other time period) that the advertisement should be most active, and Tᵢ is 1 during those hours and 0 at other times. kₜ≧0 is a constant that indicates how important this term is relative to the other terms in the formula. By way of example, kₜ=0.18 can be used.

Date of most recent click: Dᵢε[0,1]. If the user of the mobile device (if recognized) has clicked on this or a related advertisement recently (e.g., in the last 72 hours), this term increases (or decreases) the score. Dᵢ is typically set to boost the score: Dᵢ=1 for ads that have been clicked in the last 72 hours and 0 otherwise. k_{d}≧0 is a constant that indicates how important this term is relative to the other terms in the formula. By way of example, k_{d}=0.05 can be used.

Click through rate for location: Cᵢε[0,1] is the average rate that advertisement i is clicked by users in the zip code where the mobile device is currently—i.e., the number of times the advertisement has been clicked by people in that zip code divided by the number of times it has been served to that zip code. k_{c}≧0 is a constant that indicates how important this term is relative to the other terms in the formula. By way of example, k_{c}=0.075 can be used.

Click rate for content provider: Pᵢε[0,1] is the average rate that advertisement i is clicked by users who are served this advertisement when downloading content from the current mobile content provider. kₚ≧0 is a constant that indicates how important this term is relative to the other terms in the formula. By way of example, kₚ=0.075 can be used.

Progress to monthly budget completion: Bᵢε[0,1] is the fraction of the purchased block of views for advertisement i that remain (have not yet been shown) for this month, divided by the fraction of the month that has passed. Bᵢ is set to zero in the part of the month (e.g., 3 days) since this statistic is weak when so little time has passed that few data have been collected. k_{b}≧0 is a constant that says how important this term is relative to the other terms in the formula. By way of example, k_{b}=0.08 can be used.

Location relevance: Lᵢε[0,1] describes how relevant advertisement i is based on the locations of the mobile user and the advertisement. This term is more complicated to compute than the other terms, and is accordingly described in further detail below. kₗ≧0 is a constant that indicates how important this term is relative to the other terms in the formula. By way of example, kₗ=0.56 can be used.

Shaping function: kₛ≧0 is a constant that shapes the overall scoring function Sᵢ. Values near 1 seem to work well, and in the limit of large kₛ (e.g., over 10) a single largest score will dominate all others. By way of example, kₛ=1 can be used.

Computing location relevance Lᵢ is now described in further detail. A term that contributes a small amount to the score should be used when the location for the advertisement is very distant from the mobile user, and greatest when the locations are very close. There are two challenges that should be addressed. First, the location of the user may be known very precisely (e.g., a street address) or only very broadly or generally (e.g., a geographically large zip code). Second, different advertisements have different “draws,” meaning they may be relevant with varying radii. For example an ice cream shop is likely to be of interest only to people in the immediate area, whereas a specialty shop (e.g., tennis gear) may have a broader draw for those who are interested.

In accordance with one or more embodiments, a “standard deviation” is estimated for the location of the mobile user, and a radius of draw σᵢ for advertisement i is collected, and these components are factored into the computation of the location relevance.

Suppose the best estimate for the location of the mobile user is lu with a “standard deviation” of σᵤ. This information might come as an exact street address, in which case σᵤ is small (e.g., a few yards). On the other hand if the location is simply known as a zip code, lu is taken to be the approximate center of the zip code and σᵤ to be an estimate of the radius of the zip code. This radius is either measured by map data or perhaps estimated, e.g., by taking half of the average distance to the nearest six zip codes. Also suppose the location of advertisement i is li. The radius of draw σᵢ for ad i can be collected directly from the people buying the ad, or may be computed by estimating distances traveled by people who clicked on the advertisement in the past. The travel distance d can be estimated simply as the difference in the locations of the advertisement and the mobile user d=∥lu−li∥.

In accordance with one or more embodiments, the formula for location relevance Lᵢ is the integral of the product of normal distributions centered at lo and li with standard deviations σᵤ and σᵢ respectively:

$${L}_{i} \int \frac{1}{( {σ}_{u} {σ}_{u} )} ( {e}^{- {( \frac{x}{{σ}_{u}} )}^{2}} {e}^{{( \frac{x - d}{{σ}_{i}} )}^{2}} ) {d}_{x}$$

Advertisements are then selected based on the scores. In accordance with one or more embodiments, the next step is to choose randomly among all possible next locations, with probability pᵢ proportional to the scores:

$${p}_{i} = \frac{{s}_{i}}{{Σ}_{j} {s}_{j}}$$

This can be accomplished in linear time by calculating the cumulative distribution function

$${c}_{i} = {\sum }_{j \leq i} {p}_{j}$$

next choosing a random number r between 0 and 1, and finally selecting the lowest value of i for which cᵢ≧r.

Selecting an advertisement with probability proportional to the scores generated helps ensure that the best advertisements are returned most frequently, but also makes the algorithm 112 resistant to generating skewed results by ensuring delivery (and therefore data) of a wide enough sampling of advertisements.

Success can be measured based on CTR across delivery of all advertisements. One of the ways that this can be achieved is by tracking when advertisements are clicked by mobile device users and also when they are redeemed.

One of the ways in which the CTR and redemption data can be used is by dynamically altering the region of relevance for any given campaign. In this fashion, the algorithm 112 is able to route advertisements to regions that generate higher CTRs for that given campaign. Other uses include altering the weighting of the different components to produce optimal results.

An advertising system 102 in accordance with various embodiments can provide numerous benefits. For example, a mobile content provider 108 can use the advertising system 102 to increase the revenue that they earn from impressions on their mobile content. A store owner can use the system to more effectively drive traffic to the store using locally relevant mobile advertising. An individual browsing mobile content can benefit by receiving locally relevant and interesting mobile advertisements instead of untargeted and uninteresting banner advertisements.

The advertising system 102 described herein provides a powerful means of dealing with potentially ambiguous data to determine the most relevant item in a given set. While the targeting algorithm 112 is particularly useful for routing mobile advertisement given locational information, similar algorithms could be used to route physical objects or to determine degrees of relevance between other items, not just people, locations, and advertisements.

By way of example, the technology could be used in a search engine. For example, by mapping the interests of users in a two-dimensional representation of a tag cloud, the same protocol for computing overlaps in intersecting Gaussians could be effectively used to determine similarities between two people's tastes, given overlapping physical representations of their tag clouds.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The targeting algorithm 112 and other processes described above may be implemented in software, hardware, firmware, or any combination thereof. The processes are preferably implemented in one or more computer programs executing on a programmable computer including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Each computer program may be implemented in any programming language including, e.g., an assembly language, a machine language, a high-level procedural programming language, or an object-oriented programming language. The programming language may, e.g., be a compiled or interpreted programming language.

Having described preferred embodiments of the present invention, it should be apparent that modifications can be made without departing from the spirit and scope of the invention.

Method claims set forth below having steps that are numbered or designated by letters should not be considered to be necessarily limited to the particular order in which the steps are recited.

What is claimed is:

1. A method for providing advertisements to users of mobile devices, comprising the steps of:
(a) providing a plurality of advertisements and geographic region information associated with each advertisement;
(b) receiving from a mobile content provider a request for an advertisement to be delivered to a user of a mobile device along with non-standard data from which the location of the mobile device can be determined;
(c) processing the non-standard data to determine the location of the mobile device;
(d) identifying a subset of advertisements from the plurality of advertisements having geographic region information matching the location of the mobile device;
(e) ranking the advertisements in the subset of advertisements in accordance with one or more parameters; and
(f) selecting an advertisement from the ranked advertisements to be transmitted to the mobile content provider for delivery to the mobile device of the user.

2. The method of claim 1 wherein the one or more parameters include contextual information relating to the content requested by the user from the mobile content provider, time relevance, location relevance, user identity, user history, the click-through rate for an advertisement, the click-through rate for the location, or the progress to budget completion of an advertisement.

3. The method of claim 2 wherein the user history includes data indicating if the user has clicked on a given advertisement or related advertisement within a given period of time.

4. The method of claim 1 further comprising delivering the selected advertisement to the mobile content provider by (i) returning a script masked as an image, (ii) receiving a request for the image from the user's mobile device when a browser on the mobile device attempts to render the image, the request including data from a cookie stored on the user's mobile device, and (iii) using the data from the cookie in selecting an advertisement to be delivered to the user.

5. The method of claim 1 wherein the advertisement is delivered to the mobile device of the user via text message or displayed on the mobile device by a mobile web browser or mobile device application.

6. The method of claim 1 wherein the non-standard data includes natural language data providing location information.

7. The method of claim 1, wherein processing the non-standard data comprises converting the non-standard data into standard location information including longitude/latitude information, a street address, or a zip code.

8. The method of claim 1 further comprising tracking the advertisement to determine click-through data or coupon redemption data.

9. The method of claim 1 wherein the geographic region information associated with each advertisement includes information on a plurality of geographic regions having varying relevance based on the proximity of the geographic region to a given location.

10. The method of claim 9 wherein identifying a subset of advertisements comprises selecting advertisements based on the relevance of the geographic region of the advertisement containing the location of the mobile device.

11. The method of claim 1 wherein step (e) comprises assigning a score to each of the advertisements in the subset, and step (f) comprises selecting an advertisement with probability proportional to its score.

12. A computer program product residing on a computer readable medium having a plurality of instructions stored thereon which, when executed by the processor, cause that processor to:
(a) receive from a mobile content provider a request for an advertisement to be delivered to a user of a mobile device along with non-standard data from which the location of the mobile device can be determined;
(b) process the non-standard data to determine the location of the mobile device;
(c) identify a subset of advertisements from a set of stored advertisements having geographic region information matching the location of the mobile device;
(d) rank the advertisements in the subset of advertisements in accordance with one or more parameters; and
(e) select an advertisement from the ranked advertisements to be transmitted to the mobile content provider for delivery to the mobile device of the user.

13. The computer program product of claim 12 wherein the one or more parameters include contextual information relating to the content requested by the user from the mobile content provider, time relevance, location relevance, user identity, user history, the click-through rate for an advertisement, the click-through rate for the location, or the progress to budget completion of an advertisement.

14. The computer program product of claim 13 wherein the user history includes data indicating if the user has clicked on a given advertisement or related advertisement within a given period of time.

15. The computer program product of claim 12 further comprising instructions causing the processor to deliver the selected advertisement to the mobile content provider by (i) returning a script masked as an image, (ii) receiving a request for the image from the user's mobile device when a browser on the mobile device attempts to render the image, the request including data from a cookie stored on the user's mobile device, and (iii) using the data from the cookie in selecting an advertisement to be delivered to the user.

16. The computer program product of claim 12 wherein the advertisement is delivered to the mobile device of the user via text message or displayed on the mobile device by a mobile web browser or mobile device application.

17. The computer program product of claim 12 wherein the non-standard data includes natural language data providing location information.

18. The computer program product of claim 12 wherein processing the non-standard data comprises converting the non-standard data into standard location information including longitude/latitude information, a street address, or a zip code.

19. The computer program product of claim 12 further comprising instructions causing the processor to track the advertisement to determine click-through data or coupon redemption data.

20. The computer program product of claim 12 wherein the geographic region information associated with each advertisement includes information on a plurality of geographic regions having varying relevance based on the proximity of the geographic region to a given location.

21. The computer program product of claim 20 wherein identifying a subset of advertisements comprises selecting advertisements based on the relevance of the geographic region of the advertisement containing the location of the mobile device.

22. The computer program product of claim 12 wherein (d) comprises assign a score to each of the advertisements in the subset, and (e) comprises select an advertisement with probability proportional to its score.

23. An advertising system for providing advertisements to users of mobile devices, comprising:
a computer storage system for storing a plurality of advertisements and geographic region information associated with each advertisement; and
a computer server system programmed to (a) receive from a mobile content provider a request for an advertisement to be delivered to a user of a mobile device along with non-standard data from which the location of the mobile device can be determined; (b) process the non-standard data to determine the location of the mobile device; (c) identify a subset of advertisements from the plurality of advertisements stored at the computer storage system having geographic region information matching the location of the mobile device; (d) rank the advertisements in the subset of advertisements in accordance with one or more parameters; and (e) select an advertisement from the ranked advertisements to be transmitted to the mobile content provider for delivery to the mobile device of the user.

24. The advertising system of claim 23 wherein the one or more parameters include contextual information relating to the content requested by the user from the mobile content provider, time relevance, location relevance, user identity, user history, the click-through rate for an advertisement, the click-through rate for the location, or the progress to budget completion of an advertisement.

25. The advertising system of claim 24 wherein the user history includes data indicating if the user has clicked on a given advertisement or related advertisement within a given period of time.

26. The advertising system of claim 23 wherein the computer server system is programmed to deliver the selected advertisement to the mobile content provider by (i) returning a script masked as an image, (ii) receiving a request for the image from the user's mobile device when a browser on the mobile device attempts to render the image, the request including data from a cookie stored on the user's mobile device, and (iii) using the data from the cookie in selecting an advertisement to be delivered to the user.

27. The advertising system of claim 23 wherein the advertisement is delivered to the mobile device of the user via text message or displayed on the mobile device by a mobile web browser or mobile device application.

28. The advertising system of claim 23 wherein the non-standard data includes natural language data providing location information.

29. The advertising system of claim 23 wherein processing the non-standard data comprises converting the non-standard data into standard location information including longitude/latitude information, a street address, or a zip code.

30. The advertising system of claim 23 wherein the computer server system is programmed to track the advertisement to determine click-through data or coupon redemption data.

31. The advertising system of claim 23 wherein the geographic region information associated with each advertisement includes information on a plurality of geographic regions having varying relevance based on the proximity of the geographic region to a given location.

32. The advertising system of claim 31 wherein identifying a subset of advertisements comprises selecting advertisements based on the relevance of the geographic region of the advertisement containing the location of the mobile device.

33. The advertising system of claim 23 wherein (d) comprises assign a score to each of the advertisements in the subset, and (e) comprises select an advertisement with probability proportional to its score.
